(19) United States
(12) Patent Application Publication
(10) Pub. No.: US 2005/0157922 A1
(43) Pub. Date: Jul. 21, 2005

(54) Apparatus and method for color matching in print

(75) Inventor: Sung-Myun Lee, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,751

(22) Filed: Dec. 22, 2004

(30) Foreign Application Priority Data
Jan. 20, 2004 (KR) 2004-4162

(51) Int. Cl. G06K 9/00

(52) U.S. Cl. 382/167

(57) ABSTRACT

A method determines a type of color matching for a document in a system comprising a host computer for determining a document to be printed and a type of color matching for the document, and a printing apparatus for printing the document by the selected color matching. For this, whether to use at least two types of color matching in printing one document is determined, and areas are set for color matching when at least two types of color matching are used.

### CROSS-REFERENCE TO RELATED APPLICATIONS

This application claims the benefit under 35 U.S.C. §119(a) of Korean Application No. 2004-4162, filed Jan. 20, 2004, in the Korean Intellectual Property Office, the entire disclosure of which is hereby incorporated by reference.

### BACKGROUND OF THE INVENTION

1. Field of the Invention

The present invention relates to color matching in an image printing apparatus. More particularly, the present invention relates to a method for applying different types of color matching in one document as set by a user.

2. Description of the Related Art

Image printing apparatuses perform printing of images output on display devices such as monitors and televisions. The monitors, televisions, and other output display devices employ a red-green-blue (RGB) color model while the image printing apparatuses employ a cyan-magenta-yellow-black (CMYK) color model. Hereinbelow, general information on the RGB color model and the CMYK color model is provided.

The RGB color model is used in display devices, which implement colors according to a principle of adding light. In the RGB color model, using three representative primary colors, the colors become brighter as they are getting mixed. Therefore, color mixing of light as in the RGB color model is called an additive color mixture.

The CMYK color model is generally used in color printing. Since colors become more impure as thev are mixed in the CMYK color model, color mixing of inks, dyes or pigments is called a subtractive color mixture.

FIG. 1 illustrates the relationship between the RGB color model and the CMYK color model. As shown in FIG. 1, the CMYK colors can be produced using the RGB colors. For example, magenta is produced by mixing red and blue, and cyan can be produced by mixing blue and green. Mixture of green and red results in yellow. Black is included in the CMYK color model since black is not attainable by mixing the other colors such as cyan, magenta and blue. By using black in the CMYK color model, other colored inks or toners also can be saved.

As can be appreciated from the above, in order to print out an image displayed on a monitor to a printing paper, the process of color matching is required to convert the RGB color model to the CMYK color model. The color matching process is performed by a controlling part 230 of an image printing apparatus, according to the operation options selected through an operation panel by a user, which can adversely influence the overall image printing operations. Accordingly, a method is required, which is for applying and performing different types of color matching with respect to one image printing work.

### SUMMARY OF THE INVENTION

An aspect of the present invention is to solve at least the above problem and/or disadvantage and to provide at least the advantages described below. Accordingly, an aspect of the present invention is to provide an apparatus capable of performing image printing using at least two types of color matching in one document, and a method for the same.

Another aspect of the present invention is to provide an apparatus for forming a printed image in various types using at least two types of color matching in one document, and a method for the same.

In order to achieve the above-described aspects of the present invention, there is provided a method for determining a type of color matching to be used with respect to a document, the method in a system comprising a host computer for determining a document to be printed and the type of color matching to be used for the document, and an printing apparatus for printing the document by the selected type of color matching, the method comprises the steps of determining whether to use at least two types of color matching in printing one document, setting an area for color matching when at least two types of color matching are used, and determining a type of color matching to be used in the respective set areas.

The color matching matches a red-green-blue (RGB) color model to a cyan-magenta-yellow-black (CMYK) color model, the RGB color model used in a display of the host computer and the CMYK color model used in the image printing apparatus.

The area for color matching is set by inputting location information identifying the area to be evaluated for color matching. The identified area for color matching may be set by a mouse. If information on the color matching is not transmitted from the host computer, a preset color matching is used for printing the document.

In order to achieve another aspect of the present invention, there is provided an apparatus for determining a type of color matching for a document, the apparatus in a system comprising a host computer for determining a document to be printed and a type of color matching for the document, and a printing apparatus for printing the document by the selected color matching process. The apparatus comprising the host computer which determines whether to use at least two types of color matching in printing one document, sets an area for color matching when at least two color matchings are used, and determines a type of color matching to be used in the respective set areas, and the printing apparatus.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 shows relationship between a red-green-blue (RGB) color model and a cyan-magenta-yellow-black (CMYK) color model;

FIG. 2 illustrates the structure of an image printing apparatus according to an embodiment of the present invention;

FIG. 3 illustrates the structure of an image processor of the image printing apparatus according to an embodiment of the present invention;

FIG. 4 illustrates the operation of a host computer according to an embodiment of the present invention; and

FIG. 5 illustrates the operation of the image printing apparatus according to an embodiment of the present invention.

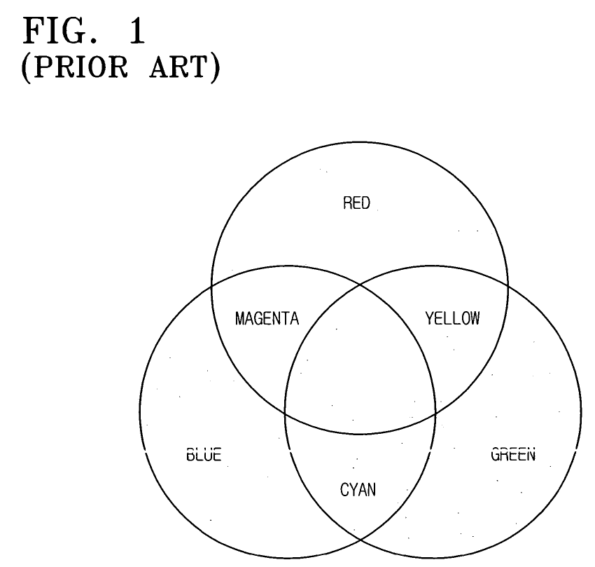

It should be understood like reference numbers refer to like features, elements, and structures throughout the drawings.

### DETAILED DESCRIPTION OF THE EXEMPLARY EMBODIMENTS

Hereinafter, an embodiment of the present invention will be described in detail with reference to the accompanying drawing figures.

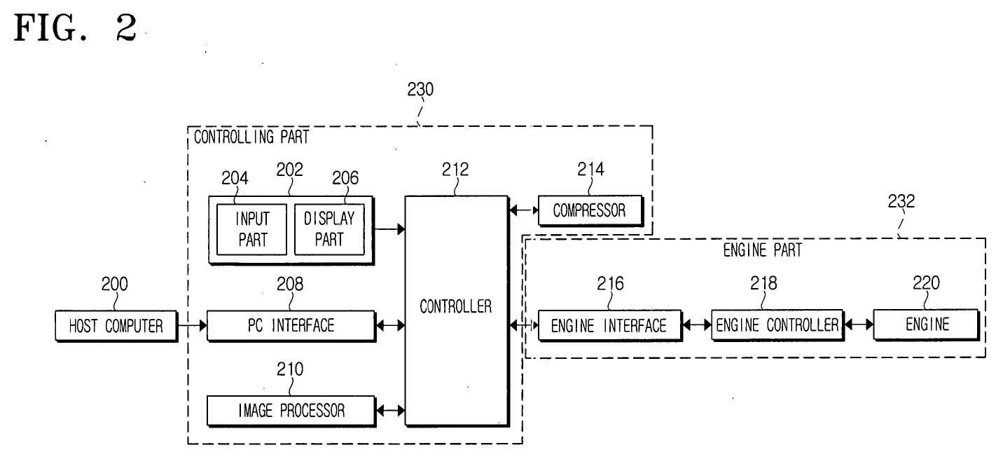

FIG. 2 shows the structure of an image printing apparatus according to an embodiment of the present invention. The image printing apparatus generally comprises a controlling part 230 and an engine part 232. The controlling part 230 analyzes image data for printing (hereinbelow, referred to as ‘printing data’) transmitted from a host computer, and stores the image data to a memory of the image printing apparatus. The controlling part 230 transmits the stored data in series so that the engine part 232 can perform printing operations with respect to the data.

The engine part 220 is a mechanical element that substantially prints out the printing data transmitted from the controlling part 230 on a paper. In a laser printer, for example, the engine part 232 comprises an organic photoconductive drum (hereinbelow, referred to as ‘photoconductive drum’), a scanning part, a developing part, a charging part, a transferring part, and a fusing part. Hereinbelow, the image printing apparatus will be described mainly with respect to the controlling part 230.

The controlling part 230 comprises an operation panel 202, a personal computer (PC) interface 208, a controller 212, an image processor 210, and a compressor 214. The operation panel 202 comprises an input part 204 and a display part 206. The PC interface 208 is accessible to the host computer 200 so as to provide a communication interface with the host computer 200. An Institute of Electrical and Electronics Engineer (IEEE) 1284, a universal serial bus (USB), a recommended standard (RS)-232C interface module, a network interface module, or the like, can be employed for the PC interface 208. The PC interface 208 provides the printing data received from the host computer 200 to the controller 212.

The operation panel 202 comprises the input part 204 which has a plurality of keys for selecting and setting functions of the image printing apparatus, and the display part 206 which is controlled by the controller 212 to display the operation status of the image printing apparatus.

The controller 212 controls the operation of a video part (not shown) according to controlling programs stored to the image printing apparatus. For example, the controller 212 produces bitmap data recognizable by the engine 220 from the printing data transmitted from the host computer 200 through the PC interface 208. The controller 212 transmits the bitmap data to an engine controller 218. Also, the controller 212 writes certain information in the engine controller 218 through an engine interface 216, or reads the information from the engine controller 218. More specifically, when reading certain information from the engine controller 218, the controller 212 reads status information of the engine 220, which is stored to a memory (not shown) of the engine controller 218. When writing certain information, the controller 212 writes the image data, which will be printed, to a memory module in the engine controller 218, which will be printed, and command information. The image processor 210 will be explained later in more detail.

A control signal of the controller 212 is transmitted to the engine controller 218 through the engine interface 216. The engine controller 218, controlled by the controller 212, controls the driving of the engine 220.

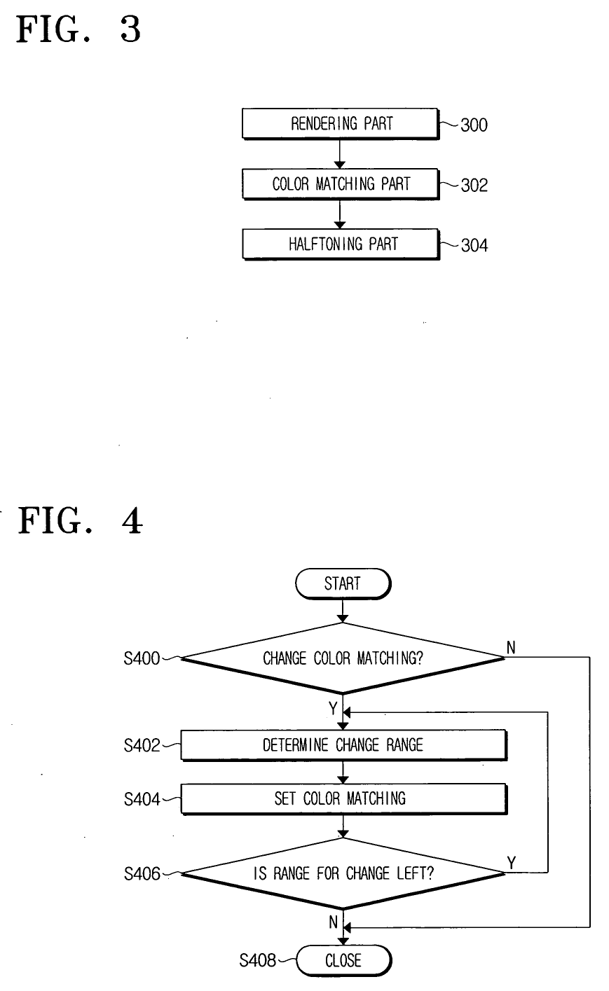

FIG. 3 shows exemplary components of the image processor according to an embodiment of the present invention. Referring to FIG. 3, the image processor comprises a rendering part 300, a halftoning part 304, and a color matching part 302. There could be components comprising the image processor besides the above, however, FIG. 3 only shows essential elements with respect to the present embodiment.

The rendering part 300 renders graphic data band-wise corresponding to a received command. Through the rendering process, resolution of a monitor is compensated to the resolution of the image printing apparatus. Usually, the resolution of the image printing apparatus is relatively higher than that of the monitor. Therefore, resolution compensation is required to output the lower resolution monitor image to the image printing apparatus capable of higher resolution reproduction.

The halftoning part 304 performs halftoning with respect to pixel data for printing. The halftoning refers to binarization of pixel data. Generally, for image printing of each pixel, the pixel data has 256 levels, typically, 0 to 255, needs to be converted to 0 or 1.

The color matching part 302 performs color matching as set by the host computer. According to an aspect of embodiments of the present invention, the color matching part 302 performs image printing of at least two types in one host computer. With reference to FIG. 4, a method for setting at least two types of color matching in one document in the host computer will now be described.

FIG. 4 illustrates the process of setting at least two types of color matching in the host computer according to an embodiment of the present invention. Referring to FIG. 4, the operation of the host computer will be described in detail according to an embodiment of the present invention.

In changing a type of the color matching in the host computer, the color matching can be changed with respect to the whole document being printed, alternatively, the color matching can be changed with respect to one document page by page. The host computer 200 may change the color matching every time an image is to be printed. Alternatively, the host computer 200 may perform the image printing by the changing the color matching throughout the document to be printed.

The host computer 200 determines whether to chance the color matching (S400). If the host computer 200 is not going to change the color matching, the host computer 200 stops its operation (S408). The host computer 200 sets a range for new color, if the host computer determines a new color matching range that is different from the existing color matching range (S402). The range can be set using a preview function with respect to the document to be printed. More specifically, the document to be printed is shown through the preview function and the range for color matching is determined. The range is set using a mouse, for example, or using location information input by a user. The range also can be set by the display part and the input part of the host computer. The range may be in various types according to information input by the user. For example, the range generally has a rectangular type, however, other various types such as a circle and a triangle are applicable for the range.

After setting the range for color matching, the host computer sets a type of color matching (S404). The color matching can be input through a keyboard, a mouse or other inputting means.

The host computer determines whether any color matching area to be changed is left. If there is a color matching area to be changed, step S402 is performed again. If there is no area requiring change, the host computer closes its operation (S408). By performing step S402 when there is a color matching area requiring change, at least two types of color matching are applied with respect to one document. Table 1 below shows the various types of color matching set with respect to one document by the host computer.

TABLE 1

| Types of color matching | Document |
|---|---|
| color matching A | area 1 |
| color matching B | area 2 |
| color matching C | area 3 |

As shown in [Table 1], the host computer is set to apply color matching type A to area 1, color matching type B to area 2, and color matching type C to area 3.

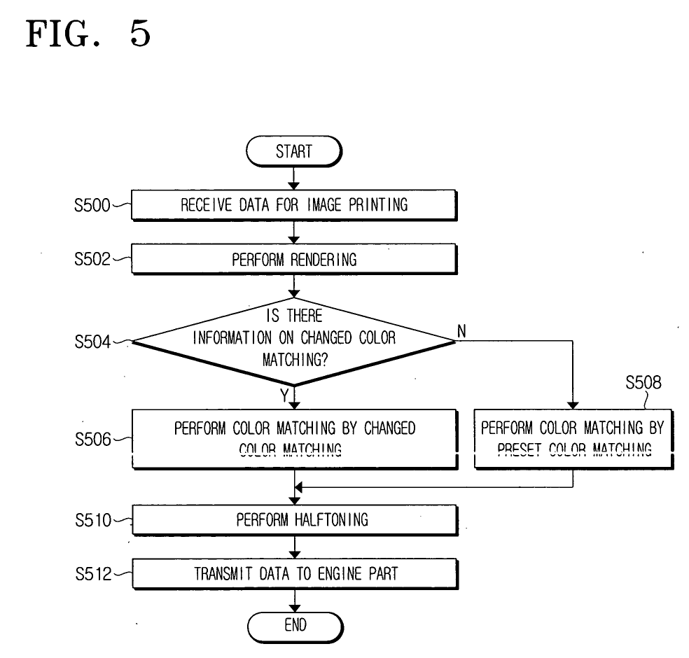

FIG. 5 illustrates the operation of the controlling part 230 of the image printing apparatus, using the color matchings set by the host computer. With reference to FIG. 5, the operation of the controlling part 230 according to an embodiment of the present invention will now be described in greater detail.

The controlling part 230 receives data for image printing (S500). The controlling part 230 performs the rendering operation with respect to the data (S502). The controlling part 230 determines whether information regarding the color matching was changed by the host computer with respect to the data (S504). When there is the information regarding the changed color matching, the controlling part 230 performs color matching as set by a user (S506). When there is no information regarding the changed color matching, the controlling part 230 moves to step S508.

The controlling part 230 performs color matching using the type of color matching that was preset (S508). On the other hand, in step S506, the controlling part 230 performs color matching with respect to the area set by the user using the types of color matching set by a user. After the color matching is performed for the set area using the set types, the color matching is performed for the area which is not set by the user, using the preset type of color matching. Of course, the above order of operation is reversible.

The controlling part 230 performs halftoning with respect to the data after the color matching (S510). The controlling part 230 transmits to the engine 220 the data being halftoned. The engine part performs printing of the image using the transmitted data. As can be appreciated from the above, the color matching changed by the user may be deleted at the same time of completing the image printing with respect to the document. The changed color matching may be stored as a default color matching after printing out the document, and therefore, the stored default color matching is used with respect to data transmitted afterwards.

Although FIG. 4 illustrates the operation in the host computer, while FIG. 5 illustrates the operation in the controlling part 230 of the image printing apparatus, the host computer may perform the operations of both FIGS. 4 and 5. In other words, the host computer may perform the color matching, the rendering, and the halftoning processes with respect to the data to be printed, and the image printing apparatus only performs image printing with respect to the data transmitted from the host computer.

As can be appreciated from the above description of the embodiments of the present invention, by using different types of color matching with respect to one document, a user can emphasize a specific part of the document for a particular type of color matching. Furthermore, the user can set a type of color matching for a specific page or part of a document, or for the whole document. In other words, the color matching can be performed page by page according to the user's selection, or with respect to the whole document.

While the invention has been shown and described with reference to certain embodiments thereof, it will be understood by those skilled in the art that various changes in form and details may be made therein without departing from the spirit and scope of the invention as defined by the appended claims.

1. A method for determining a type of color matching for a document, the method comprising the steps of:
determining whether to use at least two types of color matching in printing one document;
setting an area for color matching when at least two types of color matching are used; and
determining a type of color matching to be used in the respective set areas.

2. The method of claim 1, wherein the color matching matches a red-green-blue (RGB) color model to a cyan-magenta-yellow-black (CMYK) color model.

3. The method of claim 2, wherein the area for color matching is set by inputting location information regarding the area.

4. The method of claim 2, wherein the area for color matching is set by an input device.

5. The method of claim 2, wherein if information regarding the color matching is not transmitted from a host computer, a preset color matching is used for printing the document.

6. A system for determining a type of color matching for a document, the system comprising:
a host computer for determining whether to use at least two types of color matching in printing one document, setting an area for color matching when at least two types of color matching are used, and determining a type of color matching to be used in the respective set areas; and
a printing apparatus for printing the document by the determined type of color matching.

7. The system of claim 6, wherein the host computer the color matching matches a red-green-blue (RGB) color model to a cyan-magenta-yellow-black (CMYK) color model.

8. The system of claim 7, wherein the area for color matching is set by inputting location information on the area.

9. The system of claim 7, wherein the area for color matching is set by a mouse.

10. The system of claim 7, wherein if information on the color matching is not transmitted from the host computer, a preset color matching is used for printing the document.
